(19) United States
(12) Patent Application Publication
(10) Pub. No.: US 2025/0196489 A1
(43) Pub. Date: Jun. 19, 2025

(54) LAMINATION PROCESSING SYSTEM AND LAMINATION PROCESSING METHOD

(71) Applicant: Konica Minolta, Inc., Tokyo (JP)

(72) Inventor: Masaru OHTSUKA, Tokyo (JP)

(21) Appl. No.: 18/983,584

(22) Filed: Dec. 17, 2024

(30) Foreign Application Priority Data
Dec. 18, 2023 (JP) 2023-212649

(51) Int. Cl. B32B 38/18; B32B 37/00; B32B 37/22; B32B 38/00

(52) U.S. Cl. CPC B32B 38/185; B32B 37/0053; B32B 37/22; B32B 38/0004; B32B 2309/70

(57) ABSTRACT

A lamination processing system includes: a lamination processing section for superimposing and laminating a film on a sheet; a reader that reads the laminated sheet; and a detector that detects a positional deviation of the sheet with respect to the film based on a reading result by the reader.

### CROSS REFERENCE TO RELATED APPLICATIONS

The present invention claims priority under 35 U.S.C. § 119 to Japanese Patent Application No. 2023-212649 filed on Dec. 18, 2023, the entire content of which is incorporated herein by reference.

### BACKGROUND OF THE INVENTION

### Technical Field

The present invention relates to a lamination processing system and a lamination processing method. In particular, the present invention relates to a technique for laminating a sheet with a film.

### Description of Related Art

In the related art, a lamination processing system is known in which, after an image is formed on a sheet such as a print sheet in an image forming apparatus, a film is superimposed on the sheet and laminated (for example, Patent Literature JP1993-338039A). In this conventional lamination processing system, a sheet is sandwiched between upper and lower laminate films and is pressurized and heated, whereby the sheet is laminated in a state in which both front and back surfaces of the sheet are sealed with the films.

By the way, in the conventional lamination processing system, the position of the sheet with respect to the film may be deviated in the finish of the laminated sheet. For example, a phenomenon occurs in which the sheet protrudes from an end of the film, the sheet is arranged up to an end of the film, or the sheet is inclined with respect to the film. A sheet whose position is deviated with respect to the film becomes a defective product and is discarded. Further, if the positional deviation occurs during execution of a job, a similar positional deviation often occurs on a subsequent sheet. In this case, a large amount of film and sheets are discarded due to the execution of the job, resulting in wasteful costs.

In order to prevent a large amount of waste from being generated, for example, it is considered that a user visually checks a sheet to be output during execution of a job, and when a positional deviation occurs, the execution of the job is stopped. However, in that case, from the start to the end of the execution of the job, a user has to confirm the state of the laminated sheets output during the execution of the job, one by one. Therefore, there is a problem that a burden on the user becomes considerably large.

### SUMMARY OF THE INVENTION

The present invention has been devised to solve the above-described conventional problems. That is, an object of the present invention is to provide a lamination processing system and a lamination processing method capable of suppressing the occurrence of many products by detecting a positional deviation of a sheet with respect to a film after the film is overlapped and laminated on the sheet.

To achieve the above objects, firstly, the present invention is directed to a lamination processing system.

In one aspect of the present invention, a lamination processing system includes: a lamination processing section for superimposing and laminating a film on a sheet; a reader that reads the laminated sheet; and a detector that detects a positional deviation of the sheet with respect to the film based on a reading result by the reader.

Second, the present invention is also directed to a lamination processing method.

In one aspect of the present invention, the lamination processing method includes: overlapping and laminating a film to a sheet; reading the laminated sheet; and detecting a positional deviation of the sheet with respect to the film based on a reading result.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 illustrates a configuration example of a lamination processing system,

FIGS. 2A, FIG. 2B, and FIG. 2C illustrate the concept of a sheet reading operation by a reading section,

FIG. 3 illustrate two threshold values which are preset in the detecting section,

FIG. 4 illustrates a state in which the sheet is disposed at an appropriate position with respect to the film,

FIG. 5A and FIG. 5B illustrate a state in which a sheet is positional deviated with respect to a film in a feeding direction,

FIG. 6A and FIG. 6B illustrate a state in which a sheet is positional deviated with respect to a film in a width direction,

FIG. 7A and FIG. 7B illustrate different positional deviation from FIG. 5A, FIG. 5B, FIG. 6A and FIG. 6B,

FIG. 8 is a flowchart illustrating an example of a processing procedure in the lamination processing system,

FIG. 9 illustrate an example of the configuration of a lamination processing system in which a four way cutting section is provided in a cutting section; and

FIG. 10 illustrate an example of the configuration of a lamination processing system in which a cutting section is arranged on the downstream side of a reading section.

### DETAILED DESCRIPTION OF THE EMBODIMENTS

Hereinafter, one or more embodiments of the present invention will be described with reference to the drawings. However, the scope of the invention is not limited to the disclosed embodiments.

Hereinafter, preferred embodiments of the present invention will be described in detail with reference to the drawings. Note that elements common to the embodiments described below are denoted by the same reference signs, and redundant description thereof is omitted.

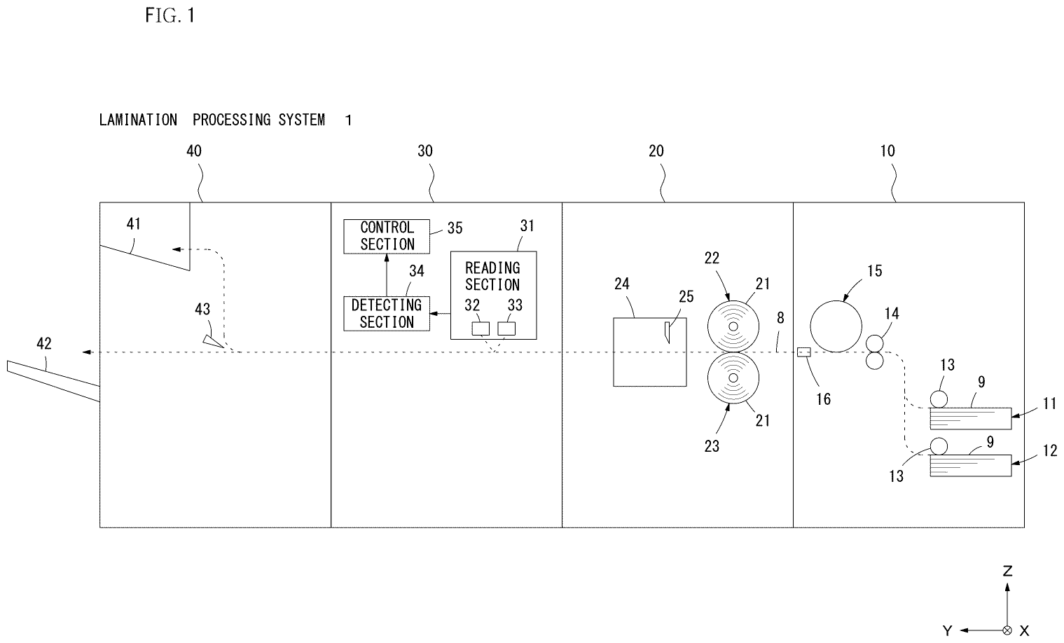

FIG. 1 illustrates an example of the configuration of a lamination processing system 1 according to an embodiment of the present invention. The lamination processing system 1 executes a job of overlaying a film 21 such as a laminate film on the sheet 9 to seal the sheet 9. For example, the lamination processing system 1 forms an image on a sheet 9 such as a print sheet, performs lamination processing by superimposing films 21 on both front and back surfaces of the sheet 9 on which the image is formed, and outputs the laminated sheet 9. The lamination processing system 1 includes an image forming section 10, a lamination processing section 20, an inspection section 30, and a sheet ejection section 40. In the lamination processing system 1, the sheet 9 is fed in Y direction shown in FIG. 1, and processing is performed with respect to the sheet 9 in each section.

The image forming section 10 includes a plurality of sheet storage sections 11 and 12 for stacking and storing a plurality of sheets 9. For example, the sheet storage sections 11 and 12 can store sheets 9 of different types or sizes. Each of the sheet storage sections 11 and 12 is provided with a sheet feeding roller 13 for feeding the sheets 9 one by one. The sheet 9 fed by the sheet feeding roller 13 is fed along a feeding path 8 provided in the lamination processing system 1. The image forming section 10 drives a sheet feeding roller 13 of a sheet storage section that stores the sheet 9 designated as a sheet to be fed and feeds the sheet 9 to the feeding path 8.

The image forming section 10 includes registration rollers 14 and an image forming unit 15 in the feeding path 8. The registration rollers 14 are formed of a pair of rollers disposed with the feeding path 8 interposed therebetween. The registration rollers 14 temporarily stops the feeding of the leading edge of the sheet 9 in a state in which the leading edge of the fed sheet 9 is in contact with the nip of the pair of rollers. Since the sheet feeding operation by the sheet feeding roller 13 is continued, a loop of the sheet 9 is formed on an upstream side of the registration rollers 14. By this loop formation, the leading edge of the sheet 9 is brought into contact with the nip of the registration rollers 14 over the entire area in the width direction of the sheet 9, and the skew of the sheet 9 is corrected. The size of the loop is changed by adjusting the temporary stop time of the leading edge of the sheet 9 by the registration rollers 14. When the size of the loop changes, the force with which the leading end of the sheet 9 is pressed against the nip between the registration rollers 14 changes. Accordingly, the correction force when the skew correction of the sheet 9 is performed is adjusted. The registration rollers 14 corrects skew of the sheet 9 and then feeds the sheet 9 toward the image forming unit 15.

The image forming unit 15 forms an image on the sheet 9 fed from the registration rollers 14. For example, the image forming unit 15 includes an image carrier such as a photosensitive drum. The image forming unit 15 forms a toner image based on image data to be printed on the image carrier. Next, the image forming unit 15 transfers the toner image onto the surface of the sheet 9, thereby forming an image on the sheet 9. Note that the image forming unit 15 further includes a fixing section (not illustrated) and fixes the toner image transferred onto the sheet 9 with the fixing section.

An adjustment mechanism 16 that adjusts the feeding position of the sheet 9 in the width direction (X direction) of the sheet 9 orthogonal to the feeding direction (Y direction) of the sheet 9 is provided on the downstream side of the image forming unit 15. The adjustment mechanism 16 can be implemented by, for example, swinging a rotation shaft of a feeding roller of the sheet 9 in a sheet plane. Further, the adjustment mechanism 16 may move the feeding position of the sheet 9 in the width direction by pressing a side edge portion of the sheet 9. Further, the adjustment mechanism 16 may be configured to be able to adjust the feeding position of the sheet 9 in the width direction of the sheet 9 by a mechanism other than these.

The lamination processing section 20 is provided on a downstream side of the image forming unit 15. The lamination processing section 20 is a section that superimposes and laminates films, such as lamination films, on both the front and back faces of the sheet 9 on which the image is formed, and which is fed from the image forming unit 15. The lamination processing section 20 includes a pair of film rolls 22 and 23 in the feeding path 8 through which the sheet 9 is fed. These film rolls 22 and 23 are arranged one above the other with the feeding path 8 for the sheet 9 in between. A long film 21 is wound around the film rolls 22 and 23. The film rolls 22 and 23 are wound with the film 21 having a width larger than the width dimension of the sheet 9 in the width direction of the sheet 9 orthogonal to the feeding direction of the sheet 9. For example, the film width of the film 21 is larger than the sheet width of the sheet 9 by about several millimeters.

The sheet 9 having the image formed thereon is fed to a nip between the pair of film rolls 22 and 23. The film rolls 22 and 23 feed the sheet 9 to the downstream side in a state where the films 21 are superimposed on both the front and back surfaces of the sheet 9 fed to the nip. A welding section (not illustrated) is provided on the downstream side of the film rolls 22 and 23 and on the upstream side of a cutting section 24 (to be described later) in order to weld the films 21 superimposed on both the front and back surfaces of the sheet 9. In this welding section, the two films 21 are welded in a state where they are superposed on each other outside the end portion of the sheet 9. Thus, the sheet 9 is sealed inside the two films 21.

The lamination processing section 20 includes a cutting section 24 on the downstream side of the film rolls 22 and 23. The cutting section 24 includes a cutter 25 extending in a direction (X direction) orthogonal to the feeding direction of the sheet 9 and cuts the long film 21 into a predetermined size for each sheet 9. That is, the cutting section 24 cuts the film 21 into a predetermined size in the feeding direction of the sheet 9. The sheet 9 obtained by cutting the film 21 into a predetermined size is then fed to the inspection section 30.

The inspection section 30 inspects whether there is a positional deviation of the sheet 9 with respect to the film 21. The inspection section 30 includes a reading section 31, a detection section 34, and a control section 35. The reading section 31 corresponds to a reader. The detection section 34 corresponds to a detector. The control section 35 corresponds to a controller.

The reading section 31 reads the sheet 9 on which the film 21 is laminated. The reading section 31 is disposed on the downstream side of the cutting section 24. Therefore, the reading section 31 reads the sheets 9 one by one after the film 21 is cut by the cutting section 24. Further, the reading section 31 can read the sheet 9 in a range wider than the width of the film 21 in the width direction of the sheet 9 orthogonal to the feeding direction of the sheet 9. For example, the reading section 31 reads the laminated sheet 9 as an image.

The reading section 31 includes a light emitting section 32 and a light receiving section 33. The light emitting section 32 corresponds to a light emitter. The light receiving section 33 corresponds to a light receiver. The light emitting section 32 emits light toward the feeding path 8 of the sheet 9. The light emitting section 32 is arranged along the width direction of the sheet 9 orthogonal to the feeding direction of the sheet 9 and irradiates the entire width of the film 21 and the sheet 9 with light. The light receiving section 33 receives light emitted from the light emitting section 32 and reflected by the surface of the film 21 or the sheet 9. The light receiving section 33 includes a plurality of light receiving elements arranged along the width direction of the sheet 9 orthogonal to the feeding direction of the sheet 9. The light receiving section 33 reads the images of the film 21 and the sheet 9 based on the amount of light received by each light receiving element.

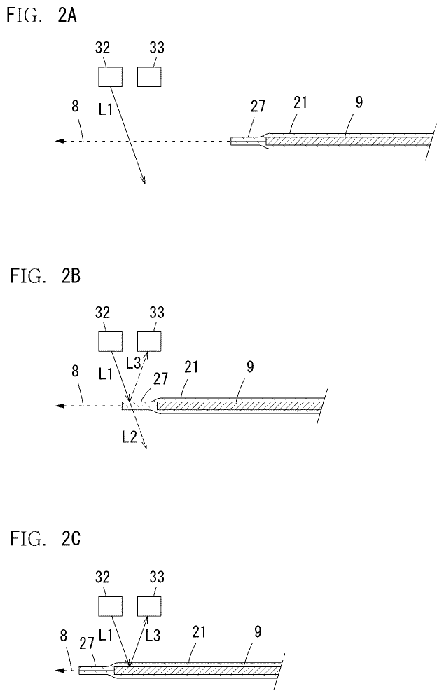

FIGS. 2A, 2B and 2C illustrates the concept of the reading operation of the sheet 9 by the reading section 31. FIG. 2A illustrates a state in which the laminated sheet 9 is not present at the reading position of the reading section 31. In the state illustrated in FIG. 2A, the light L1 emitted from the light emitting section 32 is not reflected. Therefore, the reflected light does not enter the light receiving section 33. In this case, the amount of light received by each light receiving element provided in the light receiving section 33 is extremely small.

FIG. 2B illustrates a state in which the end section 27 of the film 21 laminated on the sheet 9 has entered the reading position of the reading section 31. In the state illustrated in FIG. 2B, light emitted from the light emitting section 32 is reflected off the front face of the film 21. In this case, the light L3 reflected by the front face of the film 21 is incident on the light receiving section 33. Therefore, the amount of light received by each of the light receiving elements in the light receiving section 33 is larger than that in the state of FIG. 2A. However, since the film 21 is transparent, most of the light applied from the light emitting section 32 becomes light L2 that passes through the film 21. Therefore, the amount of increase in the amount of light received by each light receiving element in the light receiving section 33 is relatively small.

FIG. 2C illustrates a state in which the laminated sheet 9 enters a reading position by the reading section 31. In the state illustrated in FIG. 2C, light applied from the light emitting section 32 is reflected off the front face of the film 21 and reflected off the front face of the sheet 9. In this case, both the light L3 reflected by the front face of the film 21 and the light L3 reflected by the front face of the sheet 9 are incident on the light receiving section 33. Therefore, the amount of light received by each of the light receiving elements in the light receiving section 33 is further increased as compared with the state of FIG. 2B. Therefore, the amount of light received by each light receiving element in the light receiving section 33 is increased.

The example in which the light receiving section 33 detects the reflection light of the light emitted from the light emitting section 32 has been described with reference to FIGS. 2A, FIG. 2B, and FIG. 2C. However, the present invention is not limited thereto, and the light receiving section 33 may be configured to read the laminated sheet 9 by receiving light emitted from the light emitting section 32 and transmitted through the film 21 or the sheet 9. In this case, the light receiving section 33 is provided at a position opposite to the light emitting section 32 with the feeding path 8 interposed therebetween.

The detection section 34 detects a positional deviation of the sheet 9 with respect to the film 21 based on the reading result by the reading section 31. The detection section 34 first identifies the film 21 and the sheet 9 based on the reading result by the reading section 31. Specifically, the detection section 34 distinguishes between the film 21 and the sheet 9 based on the amount of light received by each light receiving element in the light receiving section 33. For example, the detection section 34 identifies a film region where the film 21 is present and a sheet region where the sheet 9 is present. The detection section 34 uses two thresholds to identify the two regions.

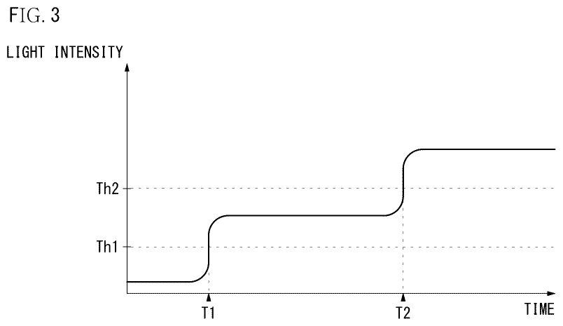

FIG. 3 illustrates two thresholds Th1 and Th2 set in advance in the detection section 34. The first threshold Th1 is a threshold-value for detecting light reflected only by the front face of the film 21 and is a threshold-value for detecting the end section 27 of the film 21 as a film region. The second threshold Th2 is a threshold-value for detecting light reflected by both the film 21 and the sheet 9 and is a threshold-value for detecting a sheet region. The second threshold Th2 are set in advance as values larger than the first threshold Th1.

For example, when the laminated sheet 9 is fed along the feeding path 8 at a constant feeding speed, the amount of light received by the light receiving section 33 changes with time as illustrated in FIG. 3. That is, when the end section 27 of the film 21 has not reached the reading position, the amount of received light is smaller than the first threshold Th1. Thereafter, when the end section 27 of the film 21 reaches the reading position, the amount of received light exceeds the first threshold Th1. However, the amount of received light does not exceed the second threshold Th2. In this case, the detection section 34 detects the end section 27 of the film 21. That is, the detection section 34 detects the end section 27 of the film 21 at the timing T1.

Thereafter, when the edge of the sheet 9 reaches the reading position, the amount of received light exceeds the second threshold Th2. In this case, the detection section 34 detects the end section of the sheet 9. That is, the detection section 34 detects the end section of the sheet 9 at the timing T2.

Further, the detection section 34 detects the end section of the film 21 and the end section of the sheet 9 not only in the feeding direction of the sheet 9 but also in the width direction of the sheet 9. As a result, the detection section 34 can detect the film region and the sheet region based on the reading result by the reading section 31.

When the detection section 34 detects the film region and the sheet region, the detection section 34 determines the overlapping state of the sheet region with respect to the film region, and detects the positional deviation of the sheet 9 with respect to the film 21. Examples of the positional deviation detectable by the detection section 34 include a positional deviation of the sheet 9 in the feeding direction, a positional deviation of the sheet 9 in the width direction, an inclination of the sheet 9 with respect to the film 21, and protrusion of the sheet 9 with respect to the film 21.

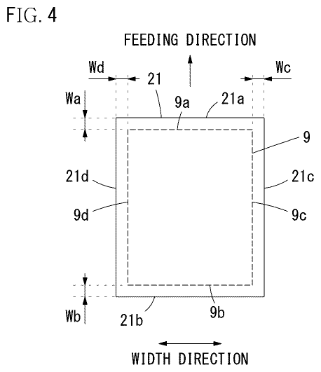

FIG. 4 is a diagram illustrating a state in which the sheet 9 is disposed at an appropriate position with respect to the film 21. When the sheet 9 is arranged at an appropriate position with respect to the film 21, the sheet 9 is positioned at the center of the film 21 as illustrated in FIG. 4. In this case, the center position of the sheet 9 and the center of the film 21 coincide with each other. Further, a film region Wa having a predetermined length exists between the leading end 9a of the sheet 9 and the leading end 21a of the film 21 in the feeding direction of the sheet 9. Further, a film region Wb having a predetermined length is present between the rear end 9b of the sheet 9 and the rear end 21b of the film 21 in the feeding direction of the sheet 9. Further, a film region Wc having a predetermined length exists between the right end 9c of the sheet 9 and the right end 21c of the film 21 in the widthwise direction of the sheet 9. Furthermore, a film region Wd having a predetermined length is also present between the left end 9d of the sheet 9 and the left end 21d of the film 21 in the widthwise direction of the sheet 9. When the sheet 9 is at an appropriate position with respect to the film 21, the lengths of the film regions Wa, Wb, Wc, and Wd are equal.

The detection section 34 determines whether the sheet 9 is arranged at an appropriate position with respect to the film 21 as illustrated in FIG. 4 based on the overlapping state of the sheet region with respect to the film region. At this time, the detection section 34 calculates the lengths of the film regions Wa, Wb, Wc, and Wd outside the sheet region, and detects the positional deviation of the sheet 9 with respect to the film 21.

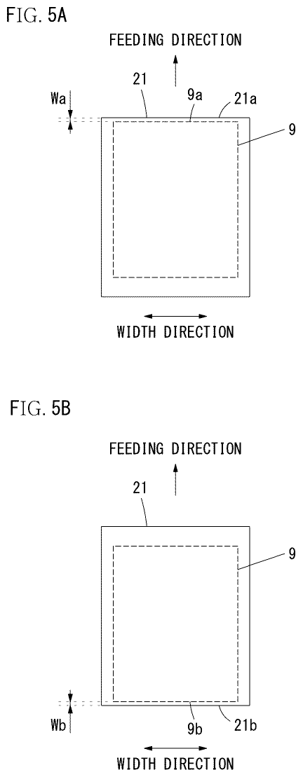

FIG. 5A and FIG. 5B illustrate a state in which the sheet 9 is positional deviated with respect to the film 21 in the feeding direction. For example, in a case where the film region Wa between the leading end 9a of the sheet 9 and the leading end 21a of the film 21 is smaller than a predetermined value as illustrated in FIG. 5A, the detection section 34 detects the positional deviation in a state where the sheet 9 is close to the leading end side of the film 21 in the feeding direction of the sheet 9. In this case, the detection section 34 calculates a difference value between the calculated value of the length of the film region Wa and the appropriate value. The difference value indicates a deviation amount of the sheet 9 on the leading end side of the film 21.

In addition, as illustrated in FIG. 5B, in a case where the film region Wb between the rear end 9b of the sheet 9 and the rear end 21b of the film 21 is smaller than a predetermined value, the detection section 34 detects the positional deviation in a state where the sheet 9 is close to the rear end side of the film 21 in the feeding direction of the sheet 9. In this case, the detection section 34 calculates a difference value between the calculated value and the appropriate value of the length of the film region Wb. The difference value indicates a deviation amount of the sheet 9 on the rear end side of the film 21.

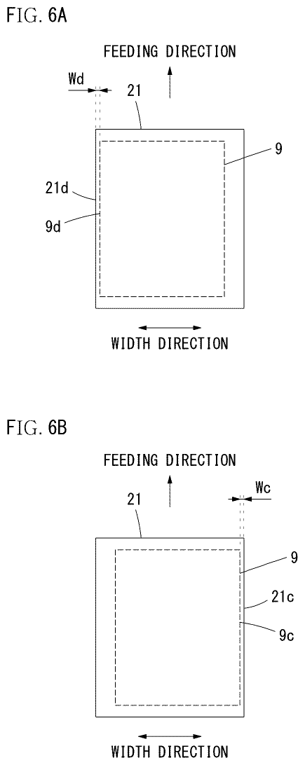

FIG. 6A and FIG. 6B illustrate a state in which the sheet 9 is positional deviated with respect to the film 21 in the widthwise direction. For example, when the film region Wd between the left end 9d of the sheet 9 and the left end 21d of the film 21 is smaller than a predetermined value as illustrated in FIG. 6A, the detection section 34 detects a positional deviation in a state where the sheet 9 is close to the left end of the film 21 in the widthwise direction of the sheet 9. In this case, the detection section 34 calculates a difference value between the calculated value and the appropriate value of the length of the film region Wd. The difference value indicates the deviation amount of the sheet 9 on the left side of the film 21.

When the film region Wc between the right end 9c of the sheet 9 and the right end 21c of the film 21 is smaller than a predetermined value as illustrated in FIG. 6B, the detection section 34 detects a positional deviation in a state where the sheet 9 is close to the right end of the film 21 in the widthwise direction of the sheet 9. In this case, the detection section 34 calculates a difference value between the calculated value and the appropriate value of the length of the film region Wc. This difference value indicates the deviation amount of the sheet 9 on the right side of the film 21.

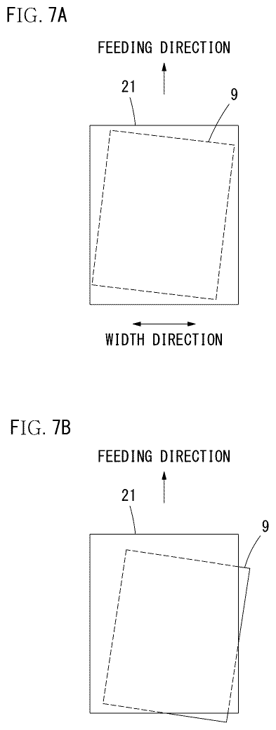

FIG. 7A and FIG. 7B illustrate a positional deviation different from FIGS. 5A, FIG. 5B, FIG. 6A and FIG. 6B. For example, as illustrated in FIG. 7A, when the sheet 9 inclines with respect to the film 21, the detection section 34 detects the inclination of the sheet 9 as the positional deviation. In this case, the detection section 34 calculates an inclination angle of the sheet 9 with respect to the film 21. The inclination angle indicates a deviation amount of the sheet 9 with respect to the film 21.

In addition, as illustrated in FIG. 7B, in a case where the sheet 9 protrudes from the end section of the film 21, the detection section 34 detects the protrusion of the sheet 9 as a positional deviation. In this case, the detection section 34 calculates a protrusion amount of the sheet 9 in each of the feeding direction and the width direction of the sheet 9. The protrusion amount indicates a deviation amount of the sheet 9 with respect to the film 21.

Upon detecting the deviation amount of the sheet 9 with respect to the film 21, the detection section 34 outputs the amount of deviation to the control section 35.

The control section 35 inspects, based on the deviation amount detected by the detection section 34, whether the laminated sheet 9 is a defective product or not, and controls execution operation of a job. For example, when the deviation amount detected by the detection section 34 is a value within a preset allowable range, the control section 35 determines that the laminated sheet 9 is a normal product.

On the other hand, when the deviation amount detected by the detection section 34 is not a value within the allowable range, the control section 35 determines that the laminated sheet 9 is a defective product. In this case, the control section 35 controls the sheet ejection section 40 to eject the sheet 9 determined to be a defective product to a tray different from that for a normal product. Further, when the control section 35 determines that the laminated sheet 9 is a defective product, the control section 35 may display detection of the defective product on a display section of an operation panel (not illustrated). Further, the control section 35 may output a warning sound indicating the detection of the defective product from a speaker (not illustrated).

In addition, the control section 35 controls a job execution operation based on the deviation amount detected by the detection section 34. For example, when the position of the sheet 9 with respect to the film 21 is deviated from the proper position in the feeding direction of the sheet 9, the control section 35 controls the feeding speed of the sheet 9 based on the deviation amount. When the feeding speed of the sheet 9 is reduced, the position of the sheet 9 moves to the rear end side of the film 21 in the feeding direction of the sheet 9. Further, when the feeding speed of the sheet 9 is increased, the position of the sheet 9 moves to the leading end side of the film 21 in the feeding direction of the sheet 9. Therefore, the control section 35 can perform control such that the position of the sheet 9 with respect to the film 21 in the transport direction of the sheet 9 is an appropriate position by changing the feeding speed of the sheet 9.

Further, for example, when the position of the sheet 9 with respect to the film 21 in the width direction of the sheet 9 is deviated from the proper position, the control section 35 controls the adjustment mechanism 16. As described above, the adjustment mechanism 16 can adjust the feeding position of the sheet 9 in the width direction of the sheet 9. The control section 35 moves the feeding position of the sheet 9 in the width direction by driving the adjustment mechanism 16 based on the deviation amount of the sheet 9 and performs control so that the position of the sheet 9 becomes an appropriate position in the width direction.

Furthermore, for example, when the sheet 9 inclines relative to the film 21, the control section 35 performs control such that the skew of the sheet 9 is appropriately corrected at the registration rollers 14. For example, the control section 35 adjusts the time for which the leading end of the sheet 9 is temporarily stopped by the registration rollers 14. Thus, the size of the loop of the sheet 9 formed on the upstream side of the registration rollers 14 changes. Therefore, the control section 35 can prevent the sheet 9 from being fed from the registration rollers 14 to the downstream side in an inclined state.

Further, for example, when the sheet 9 protrudes from the film 21, the control section 35 controls the feeding speed of the sheet 9, the adjustment mechanism 16, and the registration rollers 14 based on the deviation amount of the sheet 9. That is, the control section 35 performs control such that the subsequent sheet 9 does not protrude from the film 21.

By the control operation as described above, even if a defective product is generated during the execution of the job, the control section 35 can minimize the possibility that the subsequent sheet 9 becomes a defective product. For example, the control section 35 may perform the above-described control when determining that the laminated sheet 9 is a defective product. However, the above-described control is also applicable to a case where the laminated sheet 9 is a normal product. That is, even when the control section 35 determines that the laminated sheet 9 is a normal product, if the detection section 34 detects a positional deviation, the control section 35 preferably performs the above-described control based on the deviation amount.

The sheet ejection section 40 ejects the laminated sheet 9 fed along the feeding path 8. The sheet ejection section 40 includes a plurality of sheet ejection trays 41 and 42. Further, the sheet ejection section 40 includes a branching portion that branches the feeding path 8 of the sheet 9 to eject the sheet 9 to each of the multiple sheet ejection trays 41 and 42. The sheet ejection section 40 includes, at its junction, a switching section 43 for switching the feeding path of the sheet 9. Based on the instruction from the control section 35, the sheet ejection section 40 drives the switching section 43 and ejects the sheet 9 determined as a defective product to a sheet ejection tray different from that for a normal product.

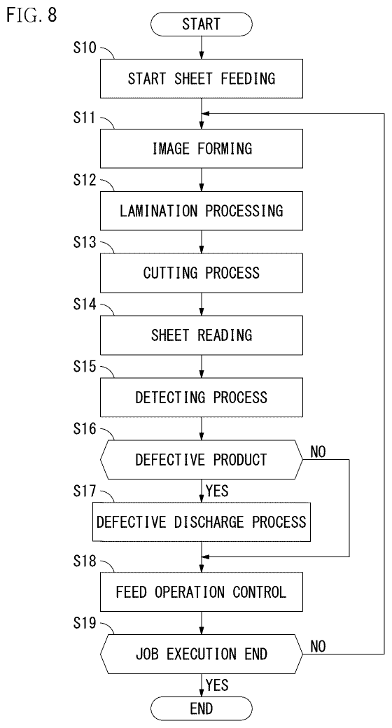

Next, operation of the lamination processing system 1 will be described. FIG. 8 is a flowchart illustrating an example of a processing procedure in the lamination processing system 1. The lamination processing system 1 starts the processing illustrated in FIG. 8 when the start of execution of a job is instructed by the user.

When starting the execution of the job, the lamination processing system 1 drives one of the multiple sheet storage sections 11 and 12 to start feeding the sheet 9 (step S10). Thus, the sheet 9 is fed along a feeding path 8 provided inside the lamination processing system 1. For example, in the case of a job of continuously feeding a plurality of sheets 9, the laminate processing system 1 continuously feeds the multiple sheets 9 to the feeding path 8 while maintaining the sheet interval of the continuous sheets 9 at a predetermined interval.

The lamination processing system 1 forms an image on the sheet 9 when the sheet 9 fed along the feeding path 8 passes through the position of the image forming unit 15 (step S11). Thereafter, when the sheet 9 on which the image has been formed passes through the position of the pair of film rolls 22 and 23, the lamination processing system 1 superimposes the films 21 on both the front and back surfaces of the sheet 9 and executes the lamination processing (step S12). Thereafter, when the laminated sheet 9 passes through the cutting section 24, the lamination processing system 1 cuts the film 21 into a predetermined size (step S13). The sheet 9 from which the film 21 has been cut is fed to the inspection section 30.

When the laminated sheet 9 passes through a reading position by the reading section 31, the lamination processing system 1 drives the reading section 31 to read the sheet 9 (step S14). Thereafter, the lamination processing system 1 operates the detection section 34 to execute a detection processing of detecting a positional deviation of the sheet 9 with respect to the film 21 (step S15). In this detection processing, the deviation amount of the sheet 9 with respect to the film 21 is calculated. The lamination processing system 1 determines whether the laminated sheet 9 is a defective product based on the deviation amount detected from the laminated sheet 9 (step S16). If the sheet 9 is a defective product (YES in step S16), the lamination processing system 1 executes ejection processing for ejecting the defective sheet 9 to a sheet ejection tray different from that for a normal product (step S17). If the sheet 9 is a normal product (NO in step S16), the processing of step S17 is not performed.

Thereafter, the lamination processing system 1 controls the feeding operation of the subsequent sheet 9 based on the deviation amount detected in step S15 (step S18). At this time, the lamination processing system 1 controls at least one of the feeding speeds of the sheet 9, the adjustment mechanism 16, and the registration rollers 14. Thus, a positional deviation of the subsequent sheet 9 with respect to the film 21 is reduced when the subsequent sheet 9 is laminated.

Next, the lamination processing system 1 determines whether to end the execution of the job (step S19). If the execution of the job is not ended (NO in step S19), the processing by the laminate processing system 1 returns to step S11. In this case, the processing in step S11 and subsequent steps is performed on the subsequent sheet 9. On the other hand, when the execution of the job ends (YES in step S19), the processing by the lamination processing system 1 ends.

As described above, the lamination processing system 1 of the present embodiment includes the reading section 31 reading the laminated sheet 9, and the detection section 34 detecting the positional deviation of the sheet 9 with respect to the film 21 based on the reading result by the reading section 31. That is, the lamination processing system 1 automatically detects the positional deviation of the sheet 9 with respect to the film 21 during the execution of the job. Therefore, it is not necessary for the user to continue to visually confirm the state of the sheet 9 during the execution of the job, and the burden on the user can be reduced as compared with the conventional art.

Further, when detecting the positional deviation of the sheet 9 with respect to the film 21, the lamination processing system 1 controls the feeding operation of the subsequent sheet 9 based on the deviation amount detected in the preceding sheet 9. Therefore, when one sheet 9 becomes a defective product, the lamination processing system 1 can prevent the subsequent sheet 9 from becoming a defective product. Therefore, it is possible to prevent many defective products from being generated during the execution of the job. Note that the lamination processing system 1 may be configured to, when detecting a defective product, automatically stop execution of a job at that timing.

A lamination processing method performed by the above-described lamination processing system 1 includes a lamination process, a reading process, a detection process, and a control process. The lamination process is a process performed in the lamination processing section 20 and is a process of superimposing and laminating a film 21 on the sheet 9. The reading process is a process performed by the reading section 31 and is a process of reading the laminated sheet 9. The detection process is a process performed by the detection section 34, and is a process of detecting the positional deviation of the sheet 9 with respect to the film 21 based on the reading result in the reading process. The control process is a process performed by the control section 35 and is a process of controlling a feeding operation of the subsequent sheet 9 based on the positional deviation amount detected in the detection process. By performing the lamination processing method including these processes in the lamination processing system 1, it is possible to reduce the burden on the user and to prevent many defective products from being generated during the execution of the job.

### Modifications

A preferred embodiment of the present invention has been described above. However, the present invention is not limited to the content described in the above embodiment, and various modification examples are applicable.

First, in the above-described embodiment, the case where the cutter 25 of the cutting section 24 cuts the film 21 in the width direction and cuts the length of the film 21 in the feeding direction of the sheet 9 into a predetermined size has been exemplified. However, the cutting section 24 is not limited to one that cuts the film 21 in the width direction. For example, the cutting section 24 may cut the film 21 into a predetermined size on all (four) sides of the sheet 9.

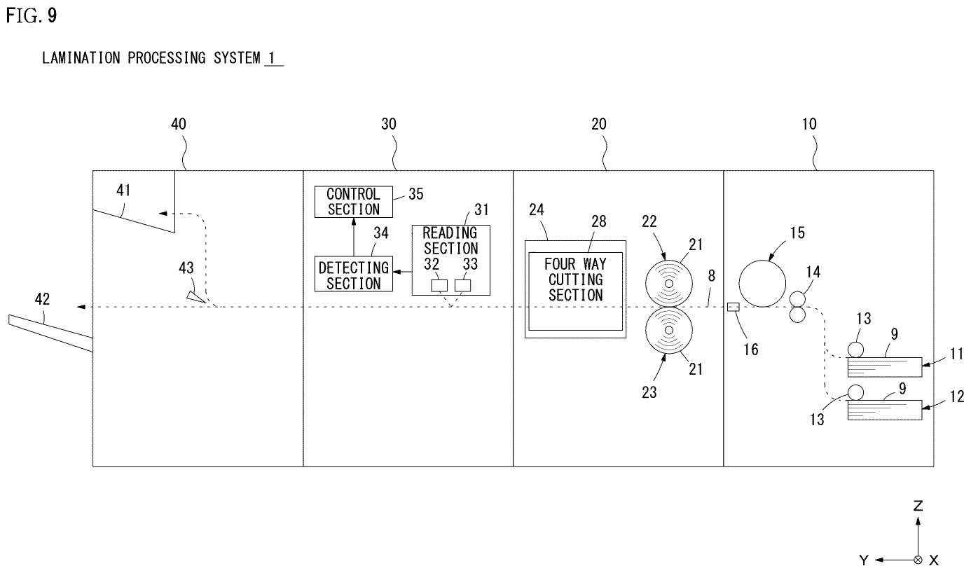

FIG. 9 illustrates a configuration example of the lamination processing system 1 in which a four way cutting section 28 is provided in the cutting section 24. The lamination processing system 1 includes a four way cutting section 28 in the cutting section 24. The four way cutting section 28 cuts the film 21 into a predetermined size on all sides of the sheet 9. That is, the four way cutting section 28 cuts the film 21 in four directions of the sheet 9. Therefore, the width of the film rolls 22 and 23 provided on the upstream side of the cutting section 24 may be considerably larger than the width of the sheet 9. Provided that, in this case, if the sheet 9 protrudes outward from a region to be cut by the four way cutting section 28, the protruding portion of the sheet 9 is cut together with the film 21. Therefore, the detection section 34 on the downstream side of the cutting section 24 does not detect the protrusion of the sheet 9 as the positional deviation of the sheet 9 with respect to the film 21. However, the detection section 34 can detect the positional deviation of the sheet 9 in the feeding direction and the width direction and can also detect the inclination of the sheet 9 with respect to the film 21.

Second, in the above-described embodiment, the case where the cutting section 24 is disposed on the upstream side of the reading section 31 has been exemplified. However, the cutting section 24 may be disposed on the downstream side of the reading section 31.

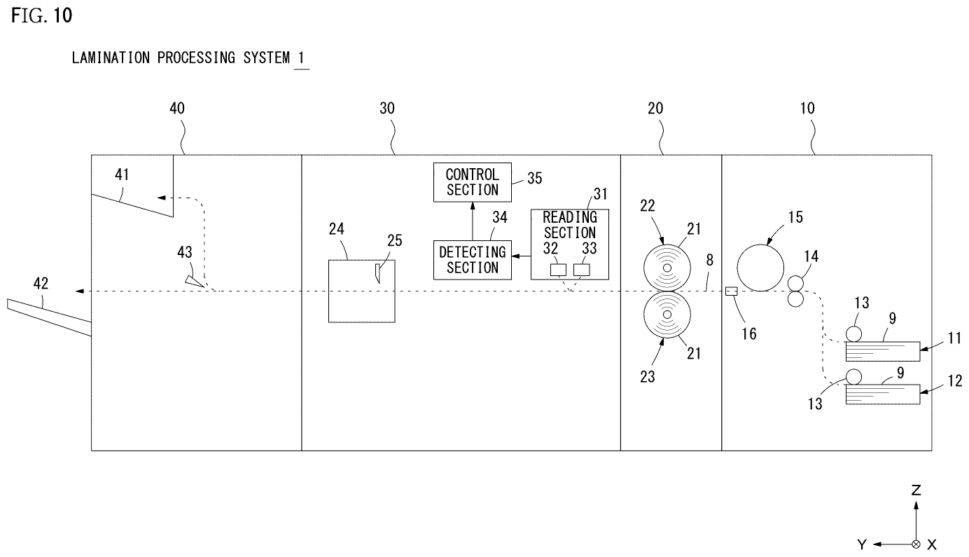

FIG. 10 illustrates a configuration example of the lamination processing system 1 in which the cutting section 24 is disposed on the downstream side of the reading section 31. As illustrated in FIG. 10, in a case where the cutting section 24 is disposed on the downstream side of the reading section 31, the film 21 is not cut when the reading section 31 reads the sheet 9. In this case, the detection section 34 cannot detect the positional deviation of the sheet 9 in the feeding direction of the sheet 9. Therefore, the detection section 34 detects the positional deviation of the sheet 9 in the width direction of the sheet 9, the inclination of the sheet 9 with respect to the film 21, and the protrusion of the sheet 9 from the end section of the film 21. Note that the cutting section 24 illustrated in FIG. 10 may be configured to include the four way cutting section 28.

Third, in the above-described embodiment, an example has been described in which the two films 21 superimposed on both the front and back surfaces of the sheet 9 are welded to each other outside the end section of the sheet 9. However, the film 21 wound around the film rolls 22 and 23 may have an adhesive layer that adheres to the front surface or the back surface of the sheet 9. In this case, the films 21 to be superimposed on both the front and back surfaces of the sheet 9 are adhered to both the front and back surfaces of the sheet 9 by adhesive layers. That is, when the film 21 having an adhesive layer is used as the type of the film 21 for laminating the sheet 9, the lamination processing system 1 can laminate the sheet 9 with the film 21 without operating the above-described welding section. In addition, in a case where the four way cutting section 28 is provided in the cutting section 24, the four way cutting section 28 can perform borderless cutting in which the film 21 does not exist outside the end section of the sheet 9.

When the film 21 having an adhesive layer is set in the lamination processing system 1 and the borderless cutting is selected as the cutting setting by the four way cutting section 28, the detection section 34 cannot detect the positional deviation of the sheet 9 with respect to the film 21 as described in the above embodiment. Therefore, it is preferable that the detection section 34 does not detect the positional deviation of the sheet 9 with respect to the film 21 when the borderless cutting is set in the cutting section 24.

Fourth, in the above-described embodiment, the example in which the detection section 34 detects the positional deviation of the sheet 9 in the feeding direction and the width direction and detects the inclination of the sheet 9 with respect to the film 21 and the protrusion from the film 21 as the positional deviation has been described. However, the embodiment is not limited thereto. For example, the detection section 34 may detect at least one of the multiple positional deviations described above.

Although embodiments of the present invention have been described and illustrated in detail, the disclosed embodiments are made for purposes of illustration and example only and not limitation. The scope of the present invention should be interpreted by terms of the appended claims.

What is claimed is:

1. A lamination processing system, comprising:
a lamination processing section for superimposing and laminating a film on a sheet;
a reader that reads the sheet laminated with the film; and
a detector that detects a positional deviation of the sheet with respect to the film based on a reading result by the reader.

2. The lamination processing system according to claim 1, wherein
the lamination processing section includes a pair of film rolls and feeds the sheet to be fed between the pair of film rolls to superimpose films on both surfaces of the sheet.

3. The lamination processing system according to claim 2, further comprising:
a cutting section that cuts the film laminated on the sheet for each sheet, wherein
the reader reads, one by one, the sheets on which the film is cut by the cutting section.

4. The lamination processing system according to claim 3, wherein
the cutting section includes a four way cutting section that cuts the film in four directions of the sheet.

5. The lamination processing system according to claim 3, wherein
the cutting section can be set to perform borderless cutting in accordance with a type of the film, and
the detector does not detect the positional deviation of the sheet with respect to the film when the borderless cutting is set in the cutting section.

6. The lamination processing system according to claim 1, wherein
the reader can read the sheet in a range wider than a film width in a width direction of the sheet orthogonal to a feeding direction of the sheet.

7. The lamination processing system according to claim 1, wherein
The detector detects the positional deviation in a sheet feeding direction and in a sheet width direction orthogonal to a feeding direction.

8. The lamination processing system according to claim 1, wherein
the detector detects the positional deviation based on a position of an end portion of the sheet with respect to an end portion of the film.

9. The lamination processing system according to claim 1, wherein
the detector detects inclination or protrusion of the sheet with respect to the film as the positional deviation.

10. The lamination processing system according to claim 2, further comprising:
a cutting section that cuts the film laminated on the sheet for each sheet, wherein
the reader reads the sheet laminated with the film before the film is cut by the cutting section, and
the detector that detects the positional deviation in a width direction orthogonal to a sheet feeding direction.

11. The lamination processing system according to claim 1, wherein
the reader includes a light emitter that emits light to the sheet laminated with the film and a light receiver that receives light emitted from the light emitter and reflected off a surface of the film or the sheet.

12. The lamination processing system according to claim 1, wherein
the reader includes a light emitter that emits light to the sheet laminated with the film and a light receiver that receives the light emitted from the light emitter and transmitted through the film or the sheet.

13. The lamination processing system according to claim 11, wherein
the reader detects a film region by comparing an amount of light received by the light receiver with a first threshold value and detects a sheet region by comparing the amount of light received by the light receiver with a second threshold value different from the first threshold value.

14. The lamination processing system according to claim 1, further comprising:
a controller that controls a feeding operation of the sheet based on a deviation amount detected by the detector.

15. The lamination processing system according to claim 14, wherein
the controller that controls a feeding speed of the sheet based on the deviation amount of the sheet in a feeding direction of the sheet.

16. The lamination processing system according to claim 14, wherein
the controller shifts a feeding position of the sheet in a width direction of the sheet based on the deviation amount of the sheet in the width direction of the sheet.

17. The lamination processing system according to claim 14, wherein
the controller controls skew correction of the sheet when the sheet is inclined with respect to the film.

18. A lamination processing method, comprising:
overlapping and laminating a film to a sheet;
reading the sheet laminated with the film; and
detecting a positional deviation of the sheet with respect to the film based on a reading result.

19. The lamination processing method according to claim 18, further comprising:
controlling the sheet feeding operation based on a detected deviation amount of the positional deviation.
